(19) United States
(12) Patent Application Publication
(10) Pub. No.: US 2026/0131853 A1
(43) Pub. Date: May 14, 2026

(54) Method and apparatus for operating a steer-by-wire steering system for a motor vehicle and steer-by-wire steering system

(71) Applicant: Ford Global Technologies, LLC, Dearborn, MI (US)

(72) Inventors: Oliver Nehls, Düsseldorf (DE); Sergio Codonesu, Aachen (DE); Hannah Denomme, South Lyon, MI (US); Alexander Ein Waldt, Köln (DE)

(21) Appl. No.: 19/387,296

(22) Filed: Nov. 12, 2025

(30) Foreign Application Priority Data
Nov. 13, 2024 (DE) 102024133193.3

(51) Int. Cl. B62D 6/00; B62D 5/04

(52) U.S. Cl. CPC B62D 6/002; B62D 5/0496

(57) ABSTRACT

The disclosure relates generally to a method and apparatus for operating a steer-by-wire steering system for a motor vehicle and to a steer-by-wire steering system. An example method includes identifying a normal angle input for a road wheel angle of steerable wheels based on a steering command, identifying an adapted angle input characteristic curve for the road wheel angle based on the normal angle input overlaid with an overlay angle characteristic curve, communicating an actuating signal based on the adapted angle input characteristic curve to a road wheel actuator, detecting at least one operating parameter influenced by the road wheel actuator during the tracking of the road wheel angle of the steerable wheels, determining an updated friction value of the road wheel actuator based on the detected at least one operating parameter, and adjusting a current friction value of the road wheel actuator based on the updated friction value.

### RELATED APPLICATION

This patent claims the benefit of German Patent Application No. 102024133193.3, which was filed on November 13, 2024. German Patent Application No. 102024133193.3 is hereby incorporated herein by reference in its entirety. Priority to German Patent Application No. 102024133193.3 is hereby claimed.

### FIELD OF THE DISCLOSURE

The disclosure relates generally to a method for operating a steer-by-wire steering system for a motor vehicle and to a steer-by-wire steering system.

### BACKGROUND

Steer-by-wire (SBW) steering systems are motor vehicle steering technology that constitutes a further development of electric power-assisted steering (also referred to as EPAS steering systems) in which a mechanical linkage transmits the driver inputs at the steering wheel directly to the wheels. The mechanical linkage is omitted in SBW steering systems. Two actuator subsystems work together to steer the vehicle: a steering wheel actuator with feedback which generates feedback torque for the driver at the steering wheel (e.g., a feedback actuator (FBA)), and a road wheel actuator (RWA) which controls at least one but typically a plurality of steerable vehicle wheels into the desired position.

### BRIEF DESCRIPTION OF THE DRAWINGS

All the features explained with regard to the different aspects can be combined individually or in (sub)combination with other aspects.

The disclosure and further advantageous embodiments and developments thereof are described and explained in detail below on the basis of the examples illustrated in the drawings, in which:

FIG. 1 shows a schematic illustration of a motor vehicle with an SBW steering system according to one embodiment.

FIG. 2 is a flowchart representative of example machine readable instructions and/or example operations that may be executed, instantiated, and/or performed by example programmable circuitry to implement the SBW steering system of FIG. 1.

FIG. 3 shows a schematic illustration of the angle characteristic curve plotted against time.

FIG. 4 shows a schematic illustration of the friction value plotted against time.

FIG. 5 is a block diagram of an example processing platform including programmable circuitry structured to execute, instantiate, and/or perform the example machine readable instructions and/or perform the example operations of FIG. 2 to implement the SBW steering system of FIG. 2.

The detailed description below, in conjunction with the attached drawings in which the same numbers refer to the same elements, is intended as a description of various embodiments of the disclosed subject-matter and not to illustrate the individual embodiments. Each embodiment described in this disclosure serves only as an example or an illustration and should not be interpreted as preferred or advantageous compared with other embodiments. The illustrative examples contained herein make no claim to completeness and do not limit the claimed subject matter to the exact forms disclosed. Various modifications of the embodiments described are readily apparent to a person skilled in the art and the general principles defined herein can be applied to other embodiments and applications without deviating from the spirit and scope of the embodiments described. The embodiments described are therefore not limited to the embodiments shown and instead have the widest possible range of application which can be combined with the principles and features disclosed here.

All the features disclosed below with reference to the exemplary embodiments and/or the accompanying Figures can be combined individually or in any desired subcombination with features of the aspects of the disclosure, including features of preferred embodiments.

### SUMMARY

An example method for operating a steer-by-wire steering system for a vehicle disclosed herein includes receiving a steering command, identifying a normal angle input for a road wheel angle of steerable wheels based on the steering command, identifying an adapted angle input characteristic curve for the road wheel angle based on the normal angle input overlaid with an overlay angle characteristic curve, communicating an actuating signal based on the adapted angle input characteristic curve to a road wheel actuator operatively coupled to the steerable wheels, wherein the actuating signal causes the road wheel actuator to track the road wheel angle of the steerable wheels based on the adapted angle input characteristic curve, detecting at least one operating parameter influenced by the road wheel actuator during the tracking of the road wheel angle of the steerable wheels, determining an updated friction value of the road wheel actuator based on the detected at least one operating parameter, and adjusting a current friction value of the road wheel actuator based on the updated friction value.

An example steer-by-wire steering system for a vehicle disclosed herein includes at least one road wheel actuator operatively coupled to steerable wheels of the vehicle, a sensor, and a control device operatively coupled to the road wheel actuator and the sensor, wherein the control device is at least configured to: identify a normal angle input for a road wheel angle of steerable wheels based on a steering command, identify an adapted angle input characteristic curve for the road wheel angle based on the normal angle input overlaid with an overlay angle characteristic curve, communicate an actuating signal to the at least one road wheel actuator based on the adapted angle input characteristic curve, the actuating signal to cause the road wheel actuator to track the road wheel angle of the steerable wheels based on the adapted angle input characteristic curve, detect at least one operating parameter influenced by the road wheel actuator during the tracking of the road wheel angle of the steerable wheels, determine an updated friction value of the road wheel actuator based on the detected at least one operating parameter, and adjust a current friction value of the road wheel actuator based on the updated friction value.

An example vehicle disclosed herein includes at least one road wheel actuator operatively coupled to steerable wheels of the vehicle, a sensor, and a control device operatively coupled to the road wheel actuator and the sensor, the control device to: identify a normal angle input for a road wheel angle of steerable wheels based on a steering command, identify an adapted angle input characteristic curve for the road wheel angle based on the normal angle input overlaid with an overlay angle characteristic curve; communicate an actuating signal to the at least one road wheel actuator based on the adapted angle input characteristic curve, the actuating signal to cause the road wheel actuator to track the road wheel angle of the steerable wheels based on the adapted angle input characteristic curve, detect at least one operating parameter influenced by the road wheel actuator during the tracking of the road wheel angle of the steerable wheels, determine an updated friction value of the road wheel actuator based on the detected at least one operating parameter, and adjust a current friction value of the road wheel actuator based on the updated friction value.

### DETAILED DESCRIPTION

For the purposes of the disclosure, the formulation "at least one of A, B, and C" means, for example, (A), (B), (C), (A and B), (A and C), (B and C), or (A, B, and C), including all further possible combinations when more than three elements are listed. In other words, the term "at least one of A and B" generally means "A and/or B", namely just "A", just "B" or "A and B".

In steering rack-based EPAS steering systems, the accumulation of water from the environment in the housing, in particular via the tie rods, can result in increased friction over time leading to corrosion. The electric motor and the driver can overcome this friction for a certain period of time in order to continue to provide assistance and to allow the movement of the steering rack to steer the vehicle. In SBW steering systems, increased friction within the road wheel actuator results in reduced tracking accuracy of the roadway angle (e.g., a greater difference between the target angle of the steerable vehicle wheels and the actual angle) by the road wheel actuator, as determined by the steering command made by the driver at the steering wheel.

Concomitant with the reduced tracking accuracy therefore is the fact that the angle controller in the form of the road wheel actuator requires a higher torque for the tracking. In addition, the time delay when tracking the angle of the steerable road wheels is increased compared with the actual point in time of the steering command. The increased friction moreover results in a reduction in the accuracy of the tracking. The frequency behavior of the angle control of the steerable vehicle wheels is moreover impaired.

A further challenge is posed by the fact that the required angle-tracking performance and the engine torque required by the road wheel actuator to comply with the requested angle in a desired fashion (despite a variation/increase in friction) are also greatly influenced by the roadway (e.g., riding) surface (e.g., ice, asphalt, gravel, bumps, a road camber, etc.), the state of the tires (e.g., divergent tire states such as varying air pressure, winter tires, or summer tires), and the state of the suspension of the motor vehicle. For example, in the suspension, stiffness and wear in the ball joints or bearings can exert a non-negligible influence on the angle-tracking performance and the required engine torque. A variation in the friction, in particular an increase, can therefore not be readily distinguished from variations in one or more of these examples of variables. As a result, the signal-to-noise ratio relating to the friction is relatively low.

Examples disclosed herein adapt the capacity for lateral guidance of the motor vehicle continuously to varying friction properties such that a desired steering feel is ensured on a permanent basis and the comfort for the driver is enabled consistently.

The object is achieved by the subject matter of the independent claims. Advantageous embodiments are specified in the dependent claims and the following description, each of which can per se or in (sub)combination constitute aspects of the disclosure. Some features are explained with respect to methods and others with respect to SBW steering systems. The corresponding aspects are, however, to be transferred reciprocally in a corresponding fashion.

According to one aspect, some embodiments of the disclosure relate to a method for operating an SBW steering system for a motor vehicle. The SBW steering system has at least one road wheel actuator and a control device coupled at least to the road wheel actuator. The method comprises at least the following steps:

The control device receives a steering command.

The control device identifies a normal angle input for a road wheel angle of steerable vehicle wheels, coupled to the road wheel actuator, of the motor vehicle based on the steering command.

The control device identifies an adapted angle input characteristic curve for the road wheel angle by the normal angle input being overlaid with an overlay angle characteristic curve.

The control device communicates to the road wheel actuator an actuating signal based on the adapted angle input characteristic curve. The actuating signal is such that the road wheel actuator tracks the road wheel angle of the steerable vehicle wheels based on the adapted angle input characteristic curve.

The control device detects at least one operating parameter influenced by the road wheel actuator, with the aid of at least one sensor of the SBW steering system, during the tracking of the road wheel angle of the steerable vehicle wheels.

The control device determines (e.g., estimates, ascertains, etc.) an updated friction value of the road wheel actuator based on the detected operating parameter.

The control device adjusts (e.g., adapts) a current friction value of the road wheel actuator based on the estimated updated friction value.

The method is based on the insight that an artificial variation of the angle characteristic curve of the steerable vehicle wheels can be used to detect the operation-dependent effect, based thereon, of the road wheel actuator. This deliberate disruption of the angle control of the steerable vehicle wheels makes it possible to identify the changes, caused by the disruption, in the operating characteristics of the road wheel actuator. Because the changes are caused at least partially by changing friction properties of the road wheel actuator and of the components of the torque-transmission path to the steerable vehicle wheels, examples disclosed herein enable monitoring of the friction characteristics beyond the operating period. The angle control can consequently be adapted correspondingly in order to enable a consistent steering feel for the driver and hence a high degree of comfort.

Although other influencing factors can also have effects on the detected operating parameters, the effects of such effects can be identified and compensated at least for repeatedly performed processes. The reason for this is that other influencing factors have an effect on the operating properties of the angle control of the steerable vehicle wheels only sporadically. Changes in the friction properties are, however, typically permanent. A defined testing sequence is thus used to enable a high degree of robustness with respect to external disruptions in terms of the estimation of the friction value of the road wheel actuator.

The method thus allows reliable and quantitative identification of changed friction properties. In other words, the method is advantageously based on the angle-tracking performance and/or the torque data of the road wheel actuator itself.

According to a further aspect, some embodiments of the disclosure relate to an SBW steering system for a motor vehicle. The SBW steering system has at least one road wheel actuator, a sensor, and a control device coupled to the road wheel actuator and the sensor. The control device is at least configured: to receive a steering command; to identify a normal angle input for a road wheel angle of steerable vehicle wheels, coupled to the road wheel actuator, of the motor vehicle based on the steering command; to identify an adapted angle input characteristic curve for the road wheel angle by the normal angle input being overlaid with an overlay angle characteristic curve; and to communicate an actuating signal based on the adapted angle input characteristic curve to the road wheel actuator. The actuating signal is such that the road wheel actuator tracks the road wheel angle of the steerable vehicle wheels based on the adapted angle input characteristic curve.

The sensor is configured to detect at least one operating parameter influenced by the road wheel actuator during the tracking of the road wheel angle of the steerable vehicle wheels and to communicate it to the control device.

The control device is moreover configured: to estimate an updated friction value of the road wheel actuator based on the detected operating parameter, and to adapt a current friction value on the basis of the estimated updated friction value.

The advantages that are achieved by the method described herein are correspondingly also obtained by the SBW steering system. In particular, the SBW steering system can be used to detect repeatedly updated friction values of the road wheel actuator and of the torque path that couples the road wheel actuator to the steerable road wheels. This allows the adaptation of the friction value when controlling the angle of the SBW steering system such that consistent steering characteristics for the lateral vehicle guidance are provided. The degree of comfort for the driver is thus improved.

The road wheel actuator is coupled at least indirectly to a steerable vehicle wheel. Optionally, the road wheel actuator can also be coupled at the same time at least indirectly to a plurality of steerable vehicle wheels, for example via a steering rack. In an alternative, the motor vehicle can also have at least one second road wheel actuator that can be coupled, for example, to steerable rear wheels of the motor vehicle, for example via an additional steering rack. The plurality of road wheel actuators can be controlled together by the control device.

Each road wheel actuator has a motor (e.g., an electric motor) to apply a torque that changes (e.g., adjusts) the orientation of the steerable vehicle wheels. For example, the road wheel actuator can apply the torque to the steering rack to set the position of the steering rack as required. The electric motor can have, for example, a winding set with three windings, i.e. a three-phase winding set. Alternatively, the electric motor can also have more winding sets.

The steering command can preferably be based on a steering wheel position of a steering wheel of the SBW steering system. For example, the driver can exert a driver torque on the steering wheel in order to turn the steering wheel into a desired angular position such that a desired lateral vehicle guidance is induced.

In an alternative, the steering command can also be made by a higher-level driving control device which functions autonomously or semi-autonomously. The steering command ultimately describes a requirement for the lateral guidance of the motor vehicle.

Optionally, the SBW steering system can have at least one steering wheel sensor that is configured to detect a steering wheel angle (e.g., a steering wheel position) of the steering wheel and to communicate the steering wheel angle to the control device. As a result, the control device can identify the type of steering command at the steering wheel and a manner according to which the lateral guidance of the motor vehicle is to be adapted.

The normal angle input corresponds to the conventional angle input, which the angle control of the control device identifies based on the steering command. A fixed, unchangeable value of the friction value of the road wheel actuator is typically considered in this.

The adapted angle input characteristic curve includes a characteristic curve specifically adapted with respect to the normal angle input. Starting with the normal angle input, an offset is applied to the angle input by the overlay angle characteristic curve in order to force an enforced divergence from the angle input.

The actuating signal can be considered as a wheel orientation signal, which is communicated to the road wheel actuator so that the latter outputs a torque in such a way that the steerable vehicle wheels follow the adapted angle input characteristic curve defined by the actuating signal. To do this, the road wheel actuator exerts a corresponding torque at least indirectly on the steerable vehicle wheels.

In order to exert the torque, the road wheel actuator expends electrical power. In addition, the exertion of the torque results in rotational and/or translational movement of components coupled to the road wheel actuator, such as a steering rack. The sensor is thus used according to the method to detect an operating parameter that is influenced directly or at least indirectly by the operation of the road wheel actuator. As a result, the effects of a changing friction value on this operating parameter can be detected and/or identified.

In some embodiments, the adapted angle input is identified by the control device only when the control device identifies at least one fulfilled trigger condition (e.g., an occurrence of at least one trigger condition). This means that a predetermined condition can be defined, which has to be fulfilled so that the adapted angle input is identified. As a result, it is possible to influence when and in what sequence the method is performed. The adapted angle input can, for example, be identified on the basis of the trigger condition when there is a suitable point in time that ensures that the estimation of the updated friction value is particularly reliable. In other words, points in time and system configurations can be identified that allow a particularly low influence of external disruptive variables on the estimation of the updated friction value to be expected for the point in time. In addition, the trigger condition can be used to identify a suitable point in time at which it can be expected that the driver of the vehicle can or will barely perceive, or not perceive at all, the test signal in the form of the overlay angle characteristic curve. As a result, a defined sequence of updates can also be ensured. This additionally entails that the control complexity can be kept at a moderate level because the repetition rate can be adapted in particular based on the specified times.

The trigger condition preferably comprises at least one of: a predetermined time interval, a predetermined driving distance covered by means of the motor vehicle, a predetermined number of ignition procedures and/or charging procedures of the motor vehicle, a predetermined service interval, an actuator temperature of the road wheel actuator and/or an ambient temperature which is below or above a respective temperature threshold value and/or within a predetermined respective temperature interval, a vehicle speed which is within a speed interval, a normal angle input which is within an angle interval and/or an angular speed interval, and/or a predetermined type of surface (e.g., riding surface).

The predetermined time interval can be used to perform the method at regular or adapted time intervals. The driving distance can be used to compensate for differences in the driving performance of different motor vehicles. The use of ignition procedures and/or charging procedures as the trigger condition makes it possible, for example, to evaluate the friction value with respect to whether a gear of the road wheel actuator or a gear coupled thereto can still move freely after a standstill (e.g., whether the friction is low enough and the gear is not locked). Locking could, for example, be caused by freezing or by corrosion that produces significant friction. The actuator temperature can be used to identify friction effects as a consequence of temperature fluctuations, for example because of very low temperatures. If water penetrates into the road wheel actuator, freezing can, for example, occur at low temperatures. In addition, low temperatures cause lubricant to become sluggish, which also causes a change in the friction properties. By taking the actuator temperature into account, the method can also be triggered in these cases by a satisfying condition. A temperature difference from the surroundings can of course also be taken into account here because especially high temperature differences can result in relatively high friction values. Taking the vehicle speed into account makes it possible to suspend the method when the motor vehicle is being guided at high vehicle speeds because at high speeds a test signal in the form of the overlay angle characteristic curve is more easily noticed by the driver because of the then typically small angle commands from the driver. On the other hand, the method can also be performed especially at high vehicle speeds because this implies a high-speed environment such as an expressway. In this case, often only a small driver torque is applied by the driver to the steering wheel because the steering commands in these driving situations are moderate. In this sense, the angle input can also be used such the method is triggered in particular when the motor vehicle is being steered (approximately) in a straight line and/or with an angular speed which corresponds to a predetermined interval, such that performance of the method, for example at high angular speeds, can be prevented. Moreover, the disruptive influences on the estimation of the updated friction value are lower at higher speeds (e.g., with regard to the friction value between the vehicle wheel and the road). The type of surface relates, for example, to predetermined types of roads. The respective current surface on which the vehicle is moving can be identified on the basis of positional data in conjunction with a position signal receiver. For example, the type of surface can be a freeway and/or an expressway on which typically only small angular changes of the steering command are made, at also typically low angular speeds. Thus, performance of the method can be prevented in the case of unsuitable surfaces, such as cobblestones or gravel.

A plurality of separate trigger conditions can of course be combined with one another. Overall, a wide variety of trigger conditions consequently result, which the control device can process in order to establish whether the method is to be performed.

In some embodiments, the overlay angle characteristic curve comprises a characteristic curve of a varying overlay angle. As a result, it is possible not only that just constant variation is effected but also that a dynamic characteristic curve is enforced. The dynamic characteristic curve causes a dynamic system response, which enables the control device to distinguish between constant and sporadic influencing variables. In addition, the flanks of the characteristic curve can be used to increase the accuracy of the evaluation (e.g., of the estimation of the updated friction value of the road wheel actuator).

The characteristic curve of the varying overlay angle preferably includes one of a sinusoidal characteristic curve, a square characteristic curve, a triangular characteristic curve, a sawtooth characteristic curve, a random characteristic curve. The method is consequently highly variable. For example, specific characteristic curves for different SBW steering systems or different driving situations can ensure a more accurate result of the evaluation.

Optionally, a frequency of the varying overlay angle characteristic curve is constant or varying. The overlay angle characteristic curve can be superimposed on the normal angle input in the form of a frequency sweep.

The overlay angle characteristic curve preferably has a duration that is shorter than a predetermined time threshold value. As a result, a time span over which the evaluation can be influenced on the basis of external factors is shortened. The reliability of the method is thus increased.

In some embodiments, the control device takes into account the in each case friction value (e.g., the current friction value and historical determinations, such as a plot or function representative, of the friction value) when controlling the road wheel angle of the steerable vehicle wheels coupled to the road wheel actuator. The friction value known at a respective point in time is thus taken into account in order to compensate the effect of the friction. A constant and homogeneous steering feel of the lateral guidance of the motor vehicle is consequently made possible for the driver.

Optionally, the detected at least one operating parameter influenced by the road wheel actuator includes at least one of: the overlay angle characteristic curve; the normal angle input based on the steering command; a wheel angle, detected with the aid of at least one wheel angle sensor, of at least one steerable vehicle wheel of the motor vehicle; a motor torque and/or a motor current of an electric motor of the road wheel actuator; an electrical power consumed or mechanical power provided by the road wheel actuator; a required amount of electrical energy of the road wheel actuator (e.g., an electrical energy requirement); an expected value of the electrical power required by the road wheel actuator based on the adapted angle input characteristic curve; and an expected value of the overlay angle characteristic curve detected with reference to the road wheel actuator based on the adapted angle input characteristic curve (e.g., the overlay angle characteristic curve that is to be expected in the case of nominal friction).

A friction value that increases over time entails that the overlay angle characteristic curve has average values that differ over time. The overlay angle characteristic curve can therefore be utilized to directly identify the friction value present at a point in time. In particular, the overlay angle characteristic curve can be correlated with the steering angle actually desired by the driver in order to identify the variation, which is caused by the changing friction values, of the overlay angle characteristic curve. The actual wheel angle of the steerable road wheels can of course also be detected. The variation in the friction means that the steerable vehicle wheels follow a same torque that is output by the road wheel actuator in a modified fashion depending on the respective friction properties. A variation in the wheel angle can therefore be detected. The road wheel actuator utilizes electrical power (e.g., voltage and current) to apply a torque. These values can be detected with the aid of the sensor in order to identify changing electrical power values (e.g., a required amount of energy), which are caused by diverging friction values. Likewise, the control device can identify an expected value of the required electrical power as the control device knows from previous operation what amounts of electrical energy are required for setting a specific angle input. In many SBW steering systems, the torque output by the electric motor of the road wheel actuator can also be detected directly with the aid of the sensor (e.g., a torque sensor).

As a further alternative, a rotational or translational movement of a component (e.g., effected by the torque output by the road wheel actuator) that is coupled to the road wheel actuator can also be detected (e.g., a position of the steering rack).

The sensor is configured to detect the respective operating parameter. For example, the sensor can be a voltage sensor, a current sensor, a torque sensor, an electricity meter, an angle sensor, and/or the like.

In some embodiments, the motor vehicle and/or the SBW steering system have wheel angle sensors. The wheel angle sensors are configured to detect a wheel angle of the steerable vehicle wheels with reference to the vehicle vertical axis (e.g., a vehicle heading) and to communicate it to a control device of the SBW steering system and/or to the road wheel actuator. The wheel angle sensor can also be used when detecting the operating parameter because it directly detects the steering angle produced of the steerable vehicle wheels.

As a result, a wide variety of operating parameters can be used for the evaluation such that the method is highly variable. Multiple operating parameters can of course also be detected, as a result of which, for example, a plausibility check and redundancy are made possible.

In some embodiments, when estimating the updated friction value, the control device takes into account at least one of: a model (e.g., a transfer function) of the control path of the SBW steering system and/or the motor vehicle; a Kalman filter and/or an estimating algorithm; changes in an amplitude response and/or a frequency response, in particular a phase shift in the frequency response of the transfer function; a change in a cut-off frequency; a time delay, an overshoot, and/or a static offset between a detected wheel angle of the steerable vehicle wheels and a nominal wheel angle (also called an angle of the nominal system) of the steerable vehicle wheels, wherein the nominal wheel angle of the steerable vehicle wheels is based on an ideal transfer function of the actuating signal; a change in an electrical power consumption of the road wheel actuator depending on successive overlay angle characteristic curves or depending on a nominal characteristic curve; and a change in a breakaway torque, wherein the breakaway torque is identified based on the requirement for an amount of electrical energy.

The force transmission path to the steerable vehicle wheels can, for example, be reproduced by the transfer function, as a result of which the accuracy in the identification of the updated friction value is increased. Thus, the suspension geometry of the motor vehicle can in particular also be taken into account. Adequate results can be obtained on the basis of the Kalman filter and/or the estimating algorithm. For example, the updated friction value can be identified on the basis of the amplitude response and the frequency response when a changed amplitude of the operating parameter is detected for predefined frequencies. This corresponds to a phase shift, which can be used to identify the updated friction value. The time delay and/or the overshoot are caused by the inertia of the system when the actuating signal is provided according to the adapted angle input characteristic curve for the road wheel actuator. By virtue of the chain of action of the force, a time delay and possibly also an overshoot in a component coupled to the road wheel actuator occurs, with reference to which the operating parameter is detected. A change in the friction value is accompanied by a change in the electrical operating characteristics of the road wheel actuator, which can be detected. The breakaway torque describes the torque that is necessary to transition from static friction to sliding friction. The breakaway torque is also influenced by a changing friction value and can be taken into account by the control device.

Overall, the updated friction value can be identified in many different ways, wherein the accuracy of the identification can be increased by taking specific parameters into account.

Optionally, the control device omits the estimation of an updated friction value when, based on at least one sensor, an external disruption acting on the motor vehicle is detected, the disruption amplitude of which is greater than a predetermined amplitude threshold value. In this case, the sensor can be, for example, an environmental sensor, a light detection and ranging (LIDAR) sensor, a radar, a camara-supported sensor, and/or a sensor coupled to the suspension of the vehicle wheels. As a result, road irregularities, which exert a sporadic external force on the motor vehicle, can be detected. If such an external exertion of force is detected, the identification of the updated friction value could possibly be falsified. The estimation of the updated friction value can therefore be abandoned in this case. Faulty control behavior is prevented as a result.

The control device preferably adapts the current friction value only when a difference between the estimated updated friction value and the current friction value is smaller than a difference threshold value. The difference threshold value constitutes a further measure for excluding one-time highly divergent estimated updated friction values from the angle control of the road wheel actuator. The friction value typically changes only slowly over time. If a high difference between the updated friction value and the current friction value is identified, the control device can consider this high difference as indicative of an incorrect estimation of the updated friction value (e.g., caused by the action of an external force). In this case, the control device prevents adaptation of (e.g., an update to) the current friction value.

In some embodiments, when adapting the current friction value, the control device takes into account at least one of: filtering of the estimated updated friction value; a sliding average value or a weighted average value of the friction value; and a gradient limitation of the change in the friction value.

The effect of one-time outliers of the friction value on the control behavior can be weakened by the filtering of the estimated updated friction value. The influence of the updated friction value can be influenced by the sliding average value or the weighted average value. The gradient limitation corresponds to a restriction of the rate of change of the updated friction value and also makes it possible to prevent significant changes in the updated friction value such that highly divergent one-time friction values are disregarded or their effect is weakened.

The adaptations are preferably performed slowly such that multiple updates of the friction value are taken into account, for example via the choice of a very slow filter coefficient in order to restrict the influence of updates with a high degree of noise or which are falsified by external disruptive variables. In particular, multiple updated friction values which are identified with reference to multiple adapted angle input characteristic curves can consequently be taken into account when updating the friction value. The influence of an individual friction value is consequently weakened.

The control device preferably selects the overlay angle characteristic curve at least in such a way that: the overlay angle characteristic curve causes only a negligible change in the steering rack force produced by the road wheel actuator; an amplitude of the overlay angle characteristic curve is smaller than an amplitude threshold value; and/or a frequency of the overlay angle characteristic curve is smaller than a frequency threshold value.

As a result, the steering behavior of the SBW steering system is influenced only to a limited extent by the method in terms of the steerable road wheels. In addition, the steering rack force is taken into account when identifying the feedback torque, which is applied to the steering wheel by the steering wheel actuator. Because the steering rack force is essentially uninfluenced by the method, the feedback torque at the steering wheel is also not influenced by the method. As a result, the effects are not discernible for the driver of the motor vehicle. In order to enable this, an amplitude and/or a frequency of the overlay angle characteristic curve can be restricted such that there is only a negligible influence of the steering rack force. As a result, a higher degree of comfort is ensured for the driver of the motor vehicle when the method is being performed. The restricting of the amplitude and/or the frequency of the overlay angle characteristic curve also makes it possible that, despite taking the overlay angle characteristic curve into account, no audible increase in noise that is disruptive for the driver is caused by the method.

Optionally, the control device additionally estimates the steering rack force produced by the road wheel actuator at least based on the steering command and the overlay angle characteristic curve. Because the overlay angle characteristic curve is known in principle, the steering rack force produced by the adapted angle input characteristic curve is identified by the overlay angle characteristic curve being taken into account, on the one hand, and the steering command, on the other hand.

During the overlaying, instead of the normal method for estimating or measuring (e.g., via a sensor) the steering rack force, the control device can utilize a steering model to calculate how high the steering rack force would be without the overlay angle characteristic curve. The estimated steering rack force is thus not disrupted by the overlay angle characteristic curve and, in turn, the feedback to the driver is not disrupted.

Alternatively, the difference in the steering rack forces (e.g., in the first case with the target angle plus the overlay angle characteristic curve, and in the second case without the overlay angle characteristic curve) can be estimated or identified based on steering models or with measurements of a nominal system, or of a system with similar friction, and thus can be used during the overlaying to correct the steering rack force.

In some embodiments, when estimating the steering rack force, the control device takes into account filtering for a time period that corresponds to the actuating signal being communicated to the road wheel actuator. The variations in the steering rack force (e.g., caused by the overlay angle characteristic curve) can, for example, be averaged by the filtering. Because the overlaying is typically triggered during situations of slow steering inputs or slowly changing target values and the overlay angle characteristic curve is dynamic, especially those portions of the change in the steering rack force (e.g., high-frequency parts) that result from the overlay angle characteristic curve are damped by the filtering, and not the rather slowly changing portions which result from the target value. The control complexity is reduced as a result.

The approaches explained here for keeping the disruptions in the steering rack force small and thus minimizing the disruption for the driver can be combined in any desired fashion.

The control device is preferably coupled to a data store in which the in each case updated friction value of the road wheel actuator is continuously stored. For the angle control, the control device can then access the data store and read and take into account the in each case current friction value.

In some embodiments, the control device can be coupled to a user interface and can output a notification to the driver and/or an external component (e.g., a communication device of a workshop or a service facility) if an updated friction value is identified that is greater than a friction threshold value. The information content for the driver of the motor vehicle and/or the external component is consequently increased such that, for example, corresponding measures can be taken, such as maintenance to counteract high friction. The user interface can be, for example, a multimedia device that is configured to output notifications to the driver and to receive user inputs (e.g., in an audio-based or tactile fashion). The driver can make user inputs with the aid of the user interface. The notification to the driver can preferably be made in the form of an indicator lamp (e.g., an indicator icon).

Optionally, the control device can trigger driving control functions. If an updated friction value is identified that is greater than a limit threshold value, the control device can initiate a vehicle state of the motor vehicle, in which the motor vehicle can be moved only with a restricted maximum speed that is less than a predetermined vehicle speed threshold value. In many situations (e.g., in the case of particularly high updated friction values), the motor vehicle can also be stopped by the control device. Faulty operating states can thus be prevented in which the motor vehicle continues to be guided by the driver despite the effectiveness of the SBW steering system being restricted.

Optionally, the control device can carry out the above-described method before each driving cycle to ensure that the friction of the road wheel actuator is low enough to guarantee correct steering behavior. If the method is not performed, the control device can optionally, for example, prevent the vehicle from driving off (e.g., in combination with other elements of the vehicle such as a gear control system, a drive control system and/or deceleration devices). In addition, the driver can be informed about this. In the case of colder temperatures, it is also possible to check whether any water has entered the road wheel actuator, or other components connected to the steering system, and has frozen, which would adversely affect or even prevent the steerability.

The SBW steering system generally comprises a steering wheel actuator. The steering wheel actuator is configured to apply a feedback torque to the steering wheel at least indirectly (e.g., via a steering column coupled to the steering wheel). The feedback torque produced by the steering wheel actuator is also utilized to give the driver torque feedback about the lateral vehicle guidance.

The steering wheel actuator includes an electric motor in order to be able to apply the feedback torque to the steering wheel. The electric motor can have, for example, a winding set with three windings (e.g., a three-phase winding set). Alternatively, the electric motor can have more winding sets.

According to a further aspect, the disclosure also relates to a computer program product, comprising commands that, when the program is executed by a computer (e.g., programmable circuitry), prompt the latter to perform the method as described herein. The advantages that are achieved by the method described herein are also obtained by the computer program product in a corresponding fashion.

According to an additional aspect, the disclosure also relates to a computer-readable storage medium including commands that, when the program is executed by a computer (e.g., programmable circuitry), prompt the latter to perform the method as described herein. The advantages which are achieved by the method described herein are also obtained by the computer-readable storage medium in a corresponding fashion.

According to a further aspect, some embodiments of the disclosure relate to a motor vehicle with a SBW steering system as described herein. The advantages that are achieved by the SBW steering system described herein are also obtained by the motor vehicle in a corresponding fashion.

Within the sense of the disclosure, motor vehicles can include land vehicles, namely, inter alia, off-road and road vehicles, such as cars, busses, trucks, and other commercial vehicles. Motor vehicles can be manned or unmanned. In some examples, the motor vehicles are at least partially electrically driven and thus have an electric motor serving as a drive means. Additionally or alternatively, the motor vehicles can have an internal combustion engine.

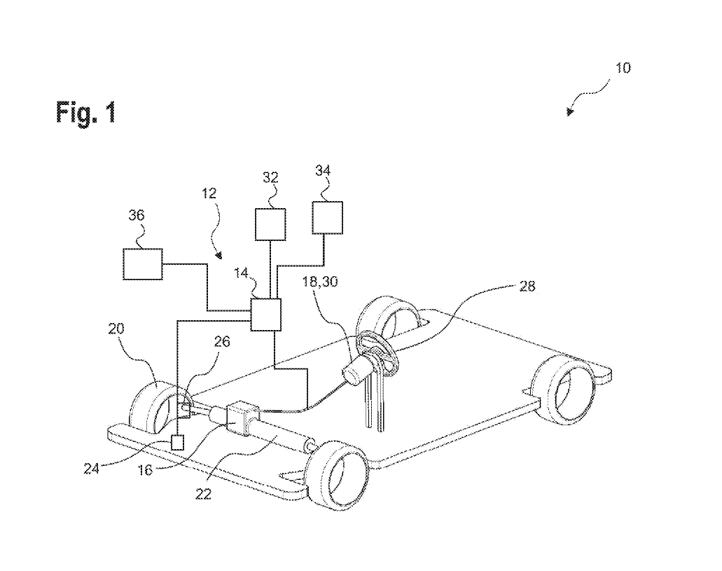

FIG. 1 shows a schematic illustration of a vehicle 10 (e.g., a motor vehicle) with a SBW steering system 12 according to one embodiment. The SBW steering system 12 includes a control device 14, a road wheel actuator 16, and a steering wheel actuator 18. The road wheel actuator 16 is coupled, at least indirectly, to steerable vehicle wheels 20 of the motor vehicle 10. Specifically, the road wheel actuator 16 is coupled to a steering rack 22, which is coupled to the steerable vehicle wheels 20 of the motor vehicle 10. The deflection of the steering rack 22 causes a change in orientation of the steerable vehicle wheels 20 about a vehicle vertical axis (e.g., to change a heading of the vehicle 10).

The motor vehicle 10 additionally has an environment sensor 24. The environment sensor 24 can also be part of the SBW steering system 12. The environment sensor 24 is configured to detect the environment of the motor vehicle 10 and to communicate corresponding environmental data to the control device 14. The environment sensor 24 can, by way of example, be a LIDAR sensor, a radar, a camera-based sensor, and/or the like. As a result, the environment sensor 24 can be used, for example, to detect road irregularities, which cause a sporadic external force on the motor vehicle 10.

In addition, the SBW steering system 12 has a sensor 26 that is configured to detect an operating parameter of the SBW steering system 12, which is influenced by the operation of the road wheel actuator 16. Additionally, data (e.g., the measurement values) associated with the operating parameter are communicated from the sensor 26 to the control device 14. The sensor 26 can, for example, take the form of a wheel angle sensor, which is configured to detect a wheel angle of the steerable vehicle wheels 20 about the vehicle vertical axis. In an alternative, the sensor 26 can take the form of a position sensor which is configured to detect a position of the steering rack 22. In a further alternative, the sensor 26 can take the form of a torque sensor which is configured to detect the torque output by the road wheel actuator 16 to a component coupled thereto. A plurality of sensor units can of course also jointly form the sensor 26, as a result of which a mutual plausibility check and redundancy are enabled.

The SBW steering system 12 also has a steering wheel 28 to which the steering wheel actuator 18 is coupled, at least indirectly (e.g., via a steering column). The steering wheel actuator 18 is configured to exert a feedback torque on the steering wheel 28 so that a feel for the lateral guidance of the motor vehicle 10 is conveyed to the driver of the motor vehicle 10. A driver of the motor vehicle 10 can issue steering commands for the motor vehicle 10 with the aid of the steering wheel 28.

The steering wheel actuator 18 includes a motor (e.g., an electric motor). The electric motor of the steering wheel actuator 18 includes at least one winding set. Each winding set of the electric motor is three-phase and configured to drive a rotor of the electric motor. Consequently, a feedback torque can be provided for the driver at the steering wheel 28 of the motor vehicle 10 by the electric motor in order to convey a feel for the lateral guidance of the motor vehicle 10 to the driver and/or in order to ensure the lateral guidance autonomously or semi-autonomously.

In addition, the SBW steering system 12 includes at least one steering wheel sensor 30 that is configured to detect a steering wheel angle (e.g., a steering wheel position) of the steering wheel 28 relative to a reference position (e.g., a center orientation, a zero position, a straight heading position). The steering wheel sensor 30 can consequently be used to detect steering commands of the driver of the motor vehicle 10 with the aid of the steering wheel 28.

According to this embodiment, the steering wheel sensor 30 is integral with the steering wheel actuator 18. In other embodiments, the steering wheel sensor 30 can, however, also be separate from the steering wheel actuator 18. The steering wheel sensor 30 is configured to communicate the detected steering wheel angle to the control device 14.

The control device 14 comprises a data-processing device. Optionally, the control device 14 can, when the wheel orientation signal is output to the road wheel actuator 16, take further parameters of the motor vehicle 10 into account, such as the vehicle speed and/or acceleration. These parameters can also be taken into account as part of the controlling of the feedback torque, which is applied to the steering wheel 28 by the steering wheel actuator 18 when a corresponding actuating signal (also called a steering wheel actuating signal) is output by the control device 14 to the steering wheel actuator 18.

The control device 14 outputs an actuating signal to control the road wheel actuator 16. Based on the actuating signal, an initial torque to be output by the road wheel actuator 16 is requested. The initial torque is exerted by the road wheel actuator 16 on the steering rack 22 such that a deflection of the steerable vehicle wheels 20 occurs.

The control device 14 outputs a steering wheel actuating signal in order to control the steering wheel actuator 18. Based on the steering wheel actuating signal, a feedback torque to be output by the steering wheel actuator 18 is requested. The steering wheel actuator 18 then outputs the feedback torque by means of which the orientation of the steering wheel 28 is changed at least indirectly.

The SBW steering system 12 has in addition a user interface 32 that is coupled to the control device 14. The user interface 32 is configured to output notifications of the control device 14 for the driver of the motor vehicle 10. The user interface 32 is moreover configured to receive user inputs from the driver. For example, predeterminable functions of the SBW steering system 12 can be adapted on the basis of the user inputs.

The SBW steering system 12 includes a data store 34, in which current values of operating parameters of the SBW steering system 12 can be stored (e.g., an in each case updated friction value of the road wheel actuator 16). The in each case current values can then be taken into account by the control device 14 when controlling the lateral vehicle guidance.

The SBW steering system 12 can of course also have a plurality of components of the same type and with generally the same function, for example a plurality of steering wheel sensors 30, as a result of which redundancy is ensured.

According to this embodiment, the motor vehicle 10 has a higher-level driving control device 36 that is configured to perform driving functions autonomously or semi-autonomously. For example, the higher-level driving control device 36 can autonomously affect lateral guidance of the motor vehicle 10. To do this, the higher-level driving control device 36 can, for example, communicate a steering command to the control device 14 of the SBW steering system 12. The steering command here corresponds to a lateral vehicle guidance of the motor vehicle 10 desired by the higher-level vehicle control device 36 in accordance with a performed function. This results in a change in the orientation of the steerable vehicle wheels 20 as the control device 14 communicates an actuating signal to the road wheel actuator 16 based on the steering command. In some examples, the control device 14 includes the higher-level driving control device 36.

The SBW steering system 12 is here illustrated as a front-axle steering system. The motor vehicle 10 and the SBW steering system 12 can optionally also have further steerable vehicle wheels 20, for example rear wheels, which are coupled to an additional common road wheel actuator 16.

Each road wheel actuator 16 includes an electric motor. The electric motor has at least one winding set, which includes a group of windings. Supply signals (e.g., phase voltages, phase currents) are applied to drive a rotor of the electric motor. The rotor can be coupled to a corresponding component of the SBW steering system 12, such as the steering rack 22. Thus, the rotor enables the movement of the steerable vehicle wheels 20. In general, the electric motor can also have more than one winding set. Each winding set is typically three-phase such that the electric motor as a whole is designed as at least three-phase, optionally also six-phase or nine-phase. If a plurality of winding sets are present, the winding sets here in each case enable a movement of the rotor of the electric motor independently of other winding sets. That is, the winding sets are separate from one another.

While an example manner of implementing the control device 14 of FIG. 1 is illustrated in FIG. 1, one or more of the elements, processes, and/or devices illustrated in FIG. 1 may be combined, divided, re-arranged, omitted, eliminated, and/or implemented in any other way. Further, the example control device 14 of FIG. 1, may be implemented by hardware alone or by hardware in combination with software and/or firmware. Thus, for example, the example control device 14, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example control device 14 of FIG. 1 may include one or more elements, processes, and/or devices in addition to, or instead of, those illustrated in FIG. 1, and/or may include more than one of any or all of the illustrated elements, processes and devices.

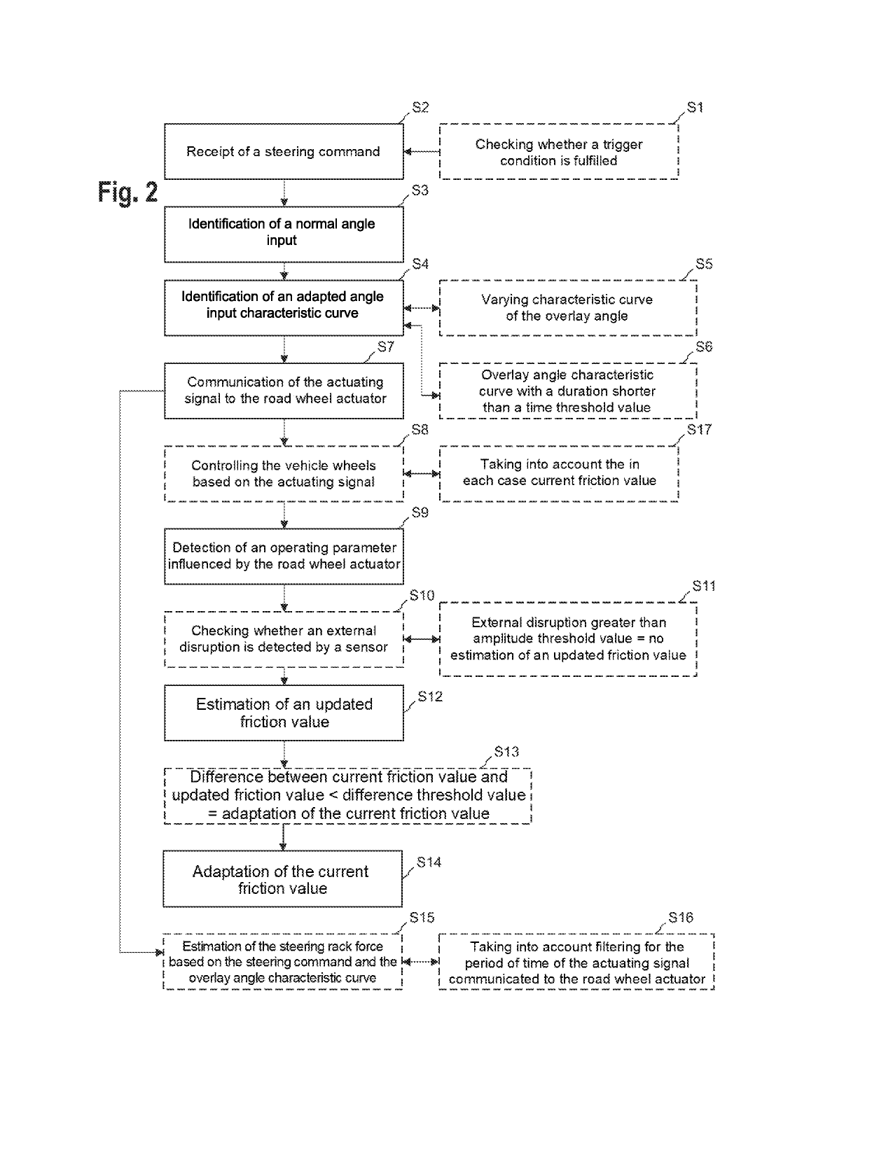

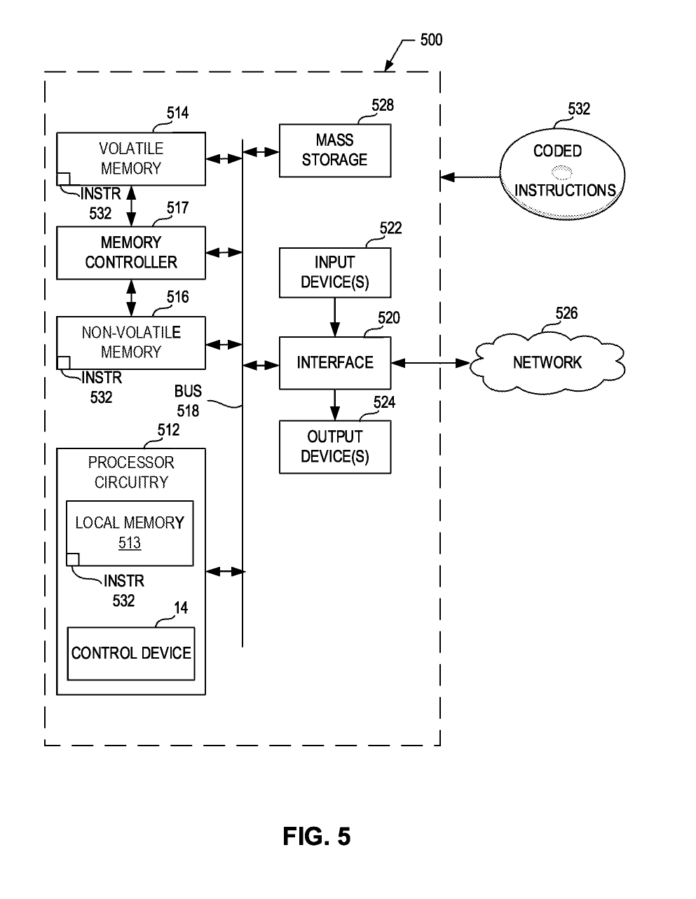

A Flowchart representative of example machine readable instructions, which may be executed by programmable circuitry to implement and/or instantiate the control device 14 of FIG. 1 and/or representative of example operations which may be performed by programmable circuitry to implement and/or instantiate the control device 14 of FIG. 1, is shown in FIG. 2. The machine readable instructions may be one or more executable programs or portion(s) of one or more executable programs for execution by programmable circuitry such as the programmable circuitry 512 shown in the example processor platform 500 discussed below in connection with FIG. 5 and/or may be one or more function(s) or portion(s) of functions to be performed by the example programmable circuitry (e.g., an FPGA). In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart illustrated in FIG. 2, many other methods of implementing the example the control device 14 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIG. 2 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/ or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 2 is a flowchart representative of example machine readable instructions and/or example operations that may be executed, instantiated, and/or performed by programmable circuitry to operate the SBW steering system 12. Optional steps are identified via dashed lines.

The operations 200 include the optional step S1 in which the control device 14 checks whether a trigger condition has been fulfilled. The trigger condition here comprises at least one of: a predetermined time interval; a predetermined driving distance covered by means of the motor vehicle; a predetermined number of ignition procedures and/or charging procedures of the motor vehicle 10; a predetermined service interval; an actuator temperature of the road wheel actuator 16 and/or an ambient temperature, which is below or above a respective temperature threshold value and/or within a predetermined respective temperature interval; a vehicle speed which is within a speed interval; a normal angle input, which is within an angle interval and/or an angular speed interval; and/or a predetermined type of surface.

The predetermined time interval can, for example, also be set on the basis of a user input. The predetermined number of ignition procedures can, for example, be helpful to check whether the gear of the road wheel actuator 16 can still move freely. The actuator temperature can be helpful as a trigger condition when changes in temperature develop during the operation of the motor vehicle 10 (e.g., when driving on a mountain). The vehicle speed and/or normal angle input can indicate that the motor vehicle 10 is being guided according to a specific driving situation (e.g., straight-line driving). In this case, no high driver torque is exerted on the steering wheel, which is advantageous for identifying an updated friction value. As a result, the possible trigger conditions can be used to identify updated friction values according to corresponding intervals on the basis of the method. A plurality of trigger conditions can of course be evaluated simultaneously individually or jointly. The further method can thus also be performed when only one individual trigger condition is fulfilled.

If the trigger condition is not fulfilled in step S1, the control device 14 can prevent the method from being performed. If the trigger condition is fulfilled, the method is continued with the step S2.

In the following step S2, the control device 14 receives a steering command. The steering command is generally based on a steering command from the driver at the steering wheel 28, such as when the steering wheel 28 is turned by said driver into a desired steering position. The control device 14 can detect the steering command at the steering wheel 28 via the steering wheel sensor 30. In an alternative, the steering command can also be based on a steering command of the higher-level driving control device 36, which performs an autonomous or semi-autonomous function.

In the following step S3 of the method, the control device 14 identifies a normal angle input for a road wheel angle of steerable vehicle wheels 20 of the motor vehicle 10, which are coupled to the road wheel actuator 16, based on the steering command. This corresponds in this respect to the conventional control function of the SBW steering system 12 in which the control device 14 outputs an actuating signal to the road wheel actuator 16 so that the road wheel actuator 16 outputs a torque in such a way that the steerable vehicle wheels 20 move according to the steering command.

In the following step S4, the control device 14 identifies an adapted angle input characteristic curve for the road wheel angle. To do this, the control device 14 overlays the normal angle input with an overlay angle characteristic curve. That is, the control device 14 adapts the normal angle input by the overlay angle characteristic curve but the overlay angle characteristic curve has the normal angle input as a support point (e.g., a guide).

In step S4, the control device 14 selects the overlay angle characteristic curve at least in such a way that: the overlay angle characteristic curve causes only a negligible change in the steering rack force produced by the road wheel actuator 16; an amplitude of the overlay angle characteristic curve is smaller than an amplitude threshold value; and/or a frequency of the overlay angle characteristic curve is smaller than a frequency threshold value.

By restricting the amplitude and/or the frequency, effects caused by the overlay angle characteristic curve that are discernible for the driver of the motor vehicle 10 can be prevented. Correspondingly, the effect on the steering rack force, which serves as a measure of the feedback at the steering wheel 28 with the aid of the steering wheel actuator 18, can be restricted.

The step S4 can be further developed by the optional step S5 by the overlay angle characteristic curve comprising a characteristic curve of a varying overlay angle. This means that the overlay angle is not constant during the overlay angle characteristic curve and instead varies. For example, the control device 14 can therefore provide, as the overlay angle characteristic curve, a characteristic curve of the overlay angle with a sinusoidal characteristic curve, a square characteristic curve, a triangular characteristic curve, a sawtooth characteristic curve, and/or a random characteristic curve. The frequency of the varying overlay angle characteristic curve can thus be constant or vary. As a result, a continual change in the angle input is ensured, which constitutes the basis for the actuating signal that the control device 14 outputs to the road wheel actuator 16.

In addition, the step S4 can also be further developed by the optional step S6, whereby the control device 14 causes the overlay angle characteristic curve to have a duration that is shorter than a time threshold value. As a result, the control device 14 ensures that the overlay angle characteristic curve (e.g., the variation superimposed on the normal angle input) continues for just a short duration. This increases the likelihood that no external disruption acts on the motor vehicle 10 during the overlay angle characteristic curve, which could otherwise falsify the evaluation on the basis of the method.

Following step S4, the method includes step S7, in which the control device 14 communicates an actuating signal based on the adapted angle input characteristic curve to the road wheel actuator 16. The actuating signal is such that the road wheel actuator 16 tracks the road wheel angle of the steerable vehicle wheels 20 based on the adapted angle input characteristic curve. Ultimately, this corresponds to the lateral guidance of the vehicle with the aid of the steerable vehicle wheels 20 with the lateral guidance being artificially adapted by the overlay angle characteristic curve.

The method then includes the optional step S8, in which the vehicle wheels 20 are controlled by the control device 14 and/or the road wheel actuator 16 based on the actuating signal from the step S7.

The method can be further developed by taking the optional step S17 into account as part of step S8. In optional step S17, the control device 14 and/or the road wheel actuator 16 then takes into account the in each case current friction value when controlling the road wheels 20 based on the actuating signal. That is, the control device 14 and/or the road wheel actuator 16 in each case takes into account the current friction value, which describes the functional relationship (e.g., chain) between the road wheel actuator 16 and the steerable vehicle wheels 20 of the motor vehicle 10. For example, the current friction value can have been identified as part of a previous performance of the method. As a result, the accuracy when controlling the vehicle wheels 20 is increased compared with known control approaches of SBW steering systems 12, in which only a constant value is used for the friction value. For this purpose, the control device 14 can, for example, access the data store 34 in which the in each case current friction value can be stored.

In the following step S9 of the method, at least one operating parameter, influenced by the road wheel actuator 16, of the motor vehicle 10 and/or of the SBW steering system 12 is detected with the aid of the sensor 26 of the SBW steering system 12 during the tracking of the road wheel angle of the steerable vehicle wheels 20. For this purpose, the sensor 26 can take the form of, for example, a position sensor that detects the position of the steering rack 22 during the tracking. In an alternative, the sensor 26 can take the form of a wheel angle sensor or take a different form, as discussed above.

Purely by way of example, the detected at least one operating parameter influenced by the road wheel actuator 16 includes at least one of: the overlay angle characteristic curve; the normal angle input based on the steering command; a wheel angle (e.g., detected with the aid of at least one wheel angle sensor) of at least one steerable vehicle wheel 20 of the motor vehicle 10; a motor torque and/or a motor current of an electric motor of the road wheel actuator 16; an electrical power consumed or mechanical power provided by the road wheel actuator 16; a required amount of electrical energy of the road wheel actuator 16; an expected value of the electrical power required by the road wheel actuator 16 based on the adapted angle input characteristic curve; and an expected value of the overlay angle characteristic curve detected with reference to the road wheel actuator 16 based on the adapted angle input characteristic curve (e.g., the overlay angle characteristic curve that is to be expected in the case of nominal friction). This means that the sensor 26 can also be configured, for example, as a current sensor or a voltage sensor which is coupled to the road wheel actuator 16. As a result, the direct electrical operating parameters of the road wheel actuator 16 can be (e.g., the amount of energy consumed). Additionally, the control device 14 can identify, from the conventional control of the road wheel actuator 16, an energy requirement the road wheel actuator 16 should have depending on the actuating signal received.

The said operating parameters constitute operating parameters to be detected which are only examples. More generally, the sensor 26 detects an operating parameter of the motor vehicle 10 and/or the SBW steering system 12 that is influenced by the operation of the road wheel actuator 16 if the road wheel actuator 16 outputs a torque.

The method then includes the optional step S10, in which a check is made by the environment sensor 24 as to whether an external disruption is acting on the motor vehicle 10, the disruption amplitude being greater than an amplitude threshold value. In this case, the actually provided estimation of the updated friction value could be falsified.

If this condition is fulfilled, and if thus the external disruption has a disruption amplitude that is greater than a predeterminable amplitude threshold value, in accordance with the optional step S11, the control device 14 prevents estimation of an updated friction value of the road wheel actuator 16. In this case, the current friction value of the road wheel actuator 16 at this point in time also continues to be used for controlling the angle of the steerable vehicle wheels 20.

If in the optional step S10 no external disruption is detected or only disruption with a disruption amplitude that is smaller than the amplitude threshold value, in the following step S12 of the method, the control device 14 determines (e.g., estimates) an updated friction value of the road wheel actuator 16 based at least partially on the operating parameter detected in step S9. In step S12 of the method, the control device 14 estimates the updated friction value based on at least one of: a transfer function of the control path of the SBW steering system 12 and/or the motor vehicle 10; a Kalman filter and/or an estimating algorithm; changes in an amplitude response and/or a frequency response of the angle characteristic curve of the steerable vehicle wheels 20 that are identified from the operating parameter, in particular a phase shift in the frequency response of the transfer function; a change in a cut-off frequency; a time delay, an overshoot, and/or a static offset between a detected wheel angle of the steerable vehicle wheels 20 and a nominal wheel angle of the steerable vehicle wheels 20, wherein the nominal wheel angle of the steerable vehicle wheels 20 is based on an ideal transfer function of the actuating signal; a change in an electrical power consumption of the road wheel actuator 16 depending on successive overlay angle characteristic curves or depending on a nominal characteristic curve; and a change in a breakaway torque, wherein the breakaway torque is identified based on a requirement for an amount of electrical energy. As a result, the updated friction value can be estimated in a customized fashion in particular with respect to the respective SBW steering system 12. For example, the individual properties of the SBW steering system 12 and/or the motor vehicle 10 (e.g., suspension geometry) are taken into account. The accuracy of the updated friction value is thus increased.

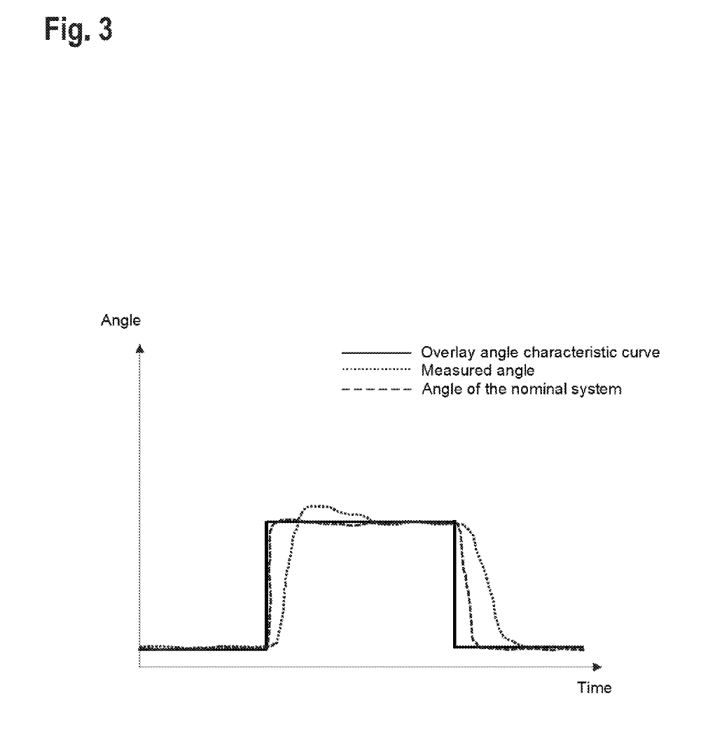

In this connection, FIG. 3 shows a schematic illustration of the angle characteristic curve plotted against time. Time is plotted on the x-axis and the angle of the steerable vehicle wheels 20 on the y-axis.

A solid line shows the overlay angle characteristic curve, which is taken into account in step S5 of the method. The overlay angle characteristic curve here has a square characteristic curve. A dashed line shows the angle characteristic curve of the (idealized) nominal system (e.g., taking into account the nominal friction value). In addition, the angle of the nominal system has variations from the overlay angle characteristic curve owing to component manufacturing tolerances, the suspension geometry, and the specific design of the torque path between the road wheel actuator 16 and the steerable vehicle wheels 20. A dotted line corresponds to the measured angle characteristic curve of the steerable vehicle wheels 20. The measured angle characteristic curve can be determined either directly with the aid of the sensor 26 or at least indirectly by the control device 14 with the aid of the sensor 26. For example, the sensor 26 can detect the operating parameter that is influenced by the road wheel actuator 16 and from which the angle characteristic curve of the steerable vehicle wheels 20 can be identified by the control device 14. In a simple example, the position of the steering rack 22 can be detected by the sensor 26. It can be seen that the measured angle characteristic curve has both an overshoot in terms of the angle of the nominal system and a time delay. The overshoot and/or the time delay can also be used to estimate the updated friction value.

Returning to the illustrated example of FIG. 2, in the following optional step S13, the control device 14 then compares the estimated updated friction value of the road wheel actuator 16 with the current friction value used beforehand in the angle control. As part thereof, the control device 14 can in particular identify a difference between the friction values.

If the difference between the current friction value and the updated friction value is smaller than a predeterminable difference threshold value, the current friction value is adapted with the estimated updated friction value in accordance with the following step S14.

If, in contrast, the difference is greater than the predeterminable difference threshold value, the adaptation of the current friction value by the estimated updated friction value in accordance with the following step S14 is prevented by the control device 14. In this case, the current friction value continues to be used. The difference is therefore a measure of how the friction generally changes only slowly over time. If therefore the difference is greater than the predeterminable difference threshold value, the control device 14 considers the difference as indicative that the identification of the updated friction value is incorrect. For example, an external disruption can result in an incorrectly estimated friction value.

Optionally, too great a difference in the case of low temperatures and a very high friction value and/or a locked steering rack 22 can indicate a frozen road wheel actuator 16 as a result of water entering and being frozen in the road wheel actuator 16. The control device 14 can then trigger corresponding countermeasures.

In the following step S14 of the method, the current friction value is adapted by the control device 14 with the estimated updated friction value. The control device 14 can store the adapted current friction value in the data store 34 and provide it for further use. In a simple variant, the current friction value can simply be overwritten by the updated friction value. However, another updating method can alternatively be used. For example, when adapting the current friction value, the control device 14 takes into account at least one of: filtering of the estimated updated friction value; a sliding average value or a weighted average value of the friction value; and/or a gradient limitation of the change (restriction of the rate of change) in the friction value.

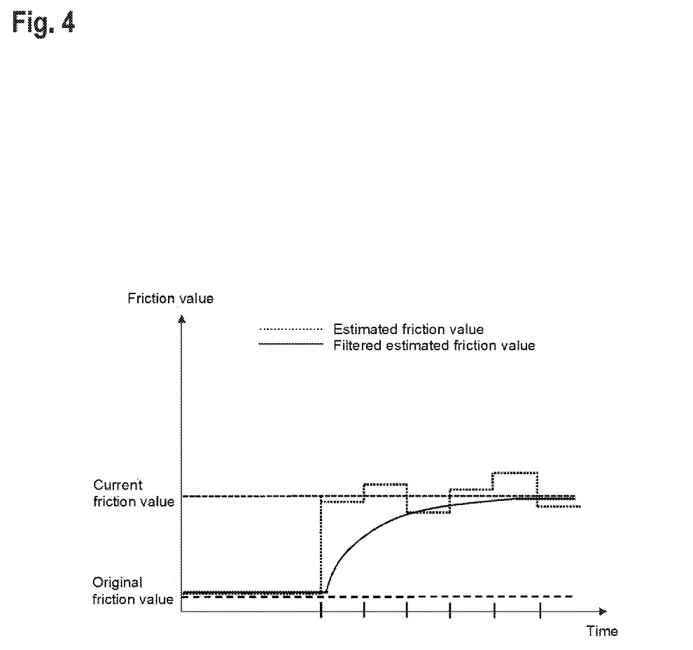

In this connection, FIG. 4 shows a simplified schematic illustration of the friction value plotted against time. Time is plotted on the x-axis and the friction value is plotted on the y-axis. A dotted line represents the estimated updated friction value. A solid line corresponds to the filtered estimated friction value. In this respect, the filtering effects an equalization of the adaptation of the current friction value with the updated estimated friction value. An abrupt change, which would occur when the current friction value is simply replaced by the updated friction value, can thus be prevented. Instead, a continuous transition between the current friction value and the updated friction value is ensured such that continuous angle control is enabled. As a result, the comfort for the driver of the motor vehicle 10 is improved. As a result, in particular a plurality of updated friction values which result from different applications of the method can be taken into account in the in each case current friction value. The influence of individual, possibly incorrect updated friction values in the current friction value is thus reduced.

Returning to FIG. 2, in step S14, the method can in addition provide the outputting of a notification to the driver of the motor vehicle 10 when the updated friction value is greater than a friction value threshold value. To do this, the control device 14 can output a corresponding notification with the aid of the user interface 32. The notification can include, for example, a prompt to service the SBW steering system 12.

In addition, the control device 14 can trigger, in step S14, a driving control function. For example, the control device 14 can trigger a reduction in speed if the updated friction value is greater than a limit threshold value. As a result, the maximum achievable speed of the motor vehicle 10 can be restricted in order to prevent undesired driving states with an SBW steering system 12 that has high friction values.

The method can be further developed by the optional step S15, which follows the step S7, and in which the control device 14 estimates the steering rack force produced by the road wheel actuator 16 at least based on the steering command and the overlay angle characteristic curve. The control device 14 can identify the feedback torque required at the steering wheel 28, which is to be applied to the steering wheel 28 by the steering wheel actuator 18, based on the steering rack force. A feel for the lateral guidance of the motor vehicle 10 is conveyed to the driver via the feedback torque.

Optionally, the step S15 can be further developed by optional step S16, in which the control device 14 takes into account filtering when estimating the steering rack force for a period of time that corresponds to the actuating signal communicated to the road wheel actuator 16. The actuating signal that is communicated to the road wheel actuator 16 corresponds to a set value of a torque that is to be output by the road wheel actuator 16. The control device 14 filters the steering rack force at least for the period of time for which the road wheel actuator 16 outputs the corresponding torque. This means that the variations in the steering rack force, which are due to the overlay angle characteristic curve, can be averaged or their effect generally can be weakened. The steering rack force is consequently equalized, as a result of which the control of the feedback torque is simplified.

A SBW steering system 12 and a method and apparatus for operating a SBW steering system are thus provided that enable the friction value of the torque transmission path between the road wheel actuator 16 and the steerable vehicle wheels 20 to be identified continuously and reliably, as well as precisely. The exertion of external forces, which cause a disruption of the identification of the updated friction value, is detected by corresponding sensors and taken into account. This makes it possible to continuously adapt the angle control of the steerable vehicle wheels 20 such that a consistent steering feel as well as a constant homogeneous lateral guidance are ensured for the driver of the motor vehicle 10 and there is a high degree of comfort.

FIG. 5 is a block diagram of an example programmable circuitry platform 500 structured to execute and/or instantiate the example machine-readable instructions and/or the example operations of FIG. 2 to implement the control device 14 of FIG. 1. The programmable circuitry platform 500 can be, for example, a server, a personal computer, a workstation, a self-learning machine (e.g., a neural network), a mobile device (e.g., a cell phone, a smart phone, a tablet such as an iPad^{TM}), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 500 of the illustrated example includes programmable circuitry 512. The programmable circuitry 512 of the illustrated example is hardware. For example, the programmable circuitry 512 can be implemented by one or more integrated circuits, logic circuits, FPGAs, microprocessors, CPUs, GPUs, VPUs, DSPs, and/or microcontrollers from any desired family or manufacturer. The programmable circuitry 512 may be implemented by one or more semiconductor based (e.g., silicon based) devices. In this example, the programmable circuitry 512 implements the control device 14 and the higher-level driving control device 36.

The programmable circuitry 512 of the illustrated example includes a local memory 513 (e.g., a cache, registers, etc.). The programmable circuitry 512 of the illustrated example is in communication with main memory 514, 516, which includes a volatile memory 514 and a non-volatile memory 516, by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517. In some examples, the memory controller 517 may be implemented by one or more integrated circuits, logic circuits, microcontrollers from any desired family or manufacturer, or any other type of circuitry to manage the flow of data going to and from the main memory 514, 516.

The programmable circuitry platform 500 of the illustrated example also includes interface circuitry 520. The interface circuitry 520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user (e.g., a human user, a machine user, etc.) to enter data and/or commands into the programmable circuitry 512. The input device(s) 522 can be implemented by, for example, an audio sensor, a microphone, a camera (still or video), a keyboard, a button, a mouse, a touchscreen, a trackpad, a trackball, an isopoint device, and/or a voice recognition system. In this example, the input devices 522 implement at least a portion of the user interface 32.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. In this example, the output devices 524 implement at least a portion of the user interface 32. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 500 of the illustrated example also includes one or more mass storage discs or devices 528 to store firmware, software, and/or data. Examples of such mass storage discs or devices 528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In this example, the mass storage discs or devices 528 implement the data store 34.

The machine readable instructions 532, which may be implemented by the machine readable instructions of FIG. 2, may be stored in the mass storage device 528, in the volatile memory 514, in the non-volatile memory 516, and/or on at least one non-transitory computer readable storage medium such as a CD or DVD which may be removable.

Specific embodiments disclosed here use circuits (for example, one or more circuits) to implement standards, protocols, methods, or technologies disclosed here, to functionally couple two or more components, to generate data, to process data, to analyze data, to generate signals, to code/decode signals, to convert signals, to transmit and/or receive signals, to control other units, etc. Circuits of any type can be used.

In one embodiment, a circuit such as the control device 14 includes, inter alia, one or more data-processing devices such as a processor (for example, a microprocessor), a central processing unit (CPU), a digital signal processor (DSP), an application-specific integrated circuit (ASIC), a field-programable gate array (FPGA), a system on a chip (SoC), or the like, or any combination thereof and can comprise discrete digital or analog circuit elements or electronics or combinations thereof. In one embodiment, the circuit comprises hardware circuit implementations (for example, implementations in analog circuits, implementations in digital circuits and the like, and combinations thereof).

In one embodiment, circuits comprise combinations of circuits and computer program products with software or firmware commands which are stored on one or more computer-readable memories and interact in order to prompt a unit to execute one of more of the protocols, methods, or technologies described here. In one embodiment, the circuitry comprises circuits, such as for example microprocessors or parts of microprocessors, which require software, firmware, and the like for their operation. In one embodiment, the circuits comprise one or more processors or parts thereof and the associated software, firmware, hardware, and the like.

Reference to quantities and numbers can be made in this disclosure. Unless explicitly stated, such quantities and numbers are not to be considered as limiting and instead as examples for the possible quantities or numbers in connection with the disclosure. In this connection, the term “a plurality” can also be used in the disclosure to refer to a quantity or number. In this connection, the term “a plurality” means any number which is greater than one, for example two, three, four, five, etc. The terms “more or less,” “approximately,” “close to,” etc. mean 5% more or less than the specified value.

Example methods, apparatus, systems, and articles of manufacture to method and apparatus for operating a steer-by-wire steering system for a motor vehicle and steer-by-wire steering system are disclosed herein. Further examples and combinations thereof include the following:

Example 1 includes a method for operating a steer-by-wire steering system for a vehicle, the method comprising receiving a steering command, identifying a normal angle input for a road wheel angle of steerable wheels based on the steering command, identifying an adapted angle input characteristic curve for the road wheel angle based on the normal angle input overlaid with an overlay angle characteristic curve, communicating an actuating signal based on the adapted angle input characteristic curve to a road wheel actuator operatively coupled to the steerable wheels, wherein the actuating signal causes the road wheel actuator to track the road wheel angle of the steerable wheels based on the adapted angle input characteristic curve, detecting at least one operating parameter influenced by the road wheel actuator during the tracking of the road wheel angle of the steerable wheels, determining an updated friction value of the road wheel actuator based on the detected at least one operating parameter, and adjusting a current friction value of the road wheel actuator based on the updated friction value.

Example 2 includes the method according to example 1, wherein the adapted angle input characteristic curve is identified in response to identification of at least one trigger condition being fulfilled.

Example 3 includes the method according to example 2, wherein the at least one trigger condition includes at least one of (i) a predetermined time interval, (ii) a predetermined driving distance covered by the vehicle, (iii) at least one of a predetermined number of ignition procedures or charging procedures of the vehicle, (iv) a predetermined service interval, (v) at least one of an actuator temperature of the road wheel actuator or an ambient temperature that is at least one of below or above a respective temperature threshold value or within a predetermined respective temperature interval, (vi) a vehicle speed that is within a speed interval, (vii) a normal angle input that is at least one of within an angle interval or an angular speed interval, and (viii) a predetermined type of riding surface.

Example 4 includes the method of any one or more of examples 1-3, wherein the overlay angle characteristic curve includes a characteristic curve of a varying overlay angle.

Example 5 includes the method according to example 4, wherein the characteristic curve of the varying overlay angle includes at least one of a sinusoidal characteristic curve, a square characteristic curve, a triangular characteristic curve, a sawtooth characteristic curve, or a random characteristic curve, and wherein a frequency of the characteristic curve of the varying overlay angle is constant.

Example 6 includes the method of any one or more of examples 4-5, wherein the characteristic curve of the varying overlay angle includes at least one of a sinusoidal characteristic curve, a square characteristic curve, a triangular characteristic curve, a sawtooth characteristic curve, or a random characteristic curve, and wherein a frequency of the characteristic curve of the varying overlay angle varies.

Example 7 includes the method of any one or more of examples 1-6, wherein the overlay angle characteristic curve has a duration that is shorter than a predetermined time threshold.

Example 8 includes the method of any one or more of examples 1-7, wherein the actuating signal is a first actuating signal, further including determining a second actuating signal to be communicated to the road wheel actuator based on the current friction value.

Example 9 includes the method of any one or more of examples 1-8, wherein the detected at least one operating parameter influenced by the road wheel actuator includes at least one of the overlay angle characteristic curve, the normal angle input based on the steering command, the road wheel angle, a motor torque and/or a motor current of the road wheel actuator, an electrical power consumed or mechanical power provided by the road wheel actuator, a required amount of electrical energy of the road wheel actuator, an expected value of the electrical power required by the road wheel actuator based on the adapted angle input characteristic curve, or an expected value of the overlay angle characteristic curve detected with reference to the road wheel actuator based on the adapted angle input characteristic curve.

Example 10 includes the method of any one or more of examples 1-9, wherein the updated friction value is determined based on at least one of a transfer function of a control path of at least one of the steer-by-wire steering system or the vehicle, at least one of a Kalman filter or an estimating algorithm, a change in at least one of an amplitude response or a frequency response of the adapted angle input characteristic curve identified based on the operating parameter, a change in a cut-off frequency, at least one of a time delay, an overshoot, or a static offset between a detected wheel angle of the steerable wheels and a nominal wheel angle of the steerable wheels, wherein the nominal wheel angle of the steerable wheels is based on an ideal transfer function of the actuating signal, a change in an electrical power consumption of the road wheel actuator associated with at least one of successive overlay angle characteristic curves or a nominal characteristic curve, or a change in a breakaway torque, wherein the breakaway torque is identified based on an electrical energy requirement consumed by the road wheel actuator.

Example 11 includes the method of any one or more of examples 1-10, further including abandoning the determination of the updated friction value when an external disruption acting on the vehicle has a disruption amplitude that is greater than a predetermined amplitude threshold.

Example 12 includes the method of any one or more of examples 1-11, wherein adjusting the current friction value occurs when a difference between the determined updated friction value and the current friction value is smaller than a difference threshold value.

Example 13 includes the method of any one or more of examples 1-12, wherein the current friction value is adjusted based on at least one of (i) filtering of the determined updated friction value, (ii) a sliding average value or a weighted average value associated with the updated friction value, or (iii) a gradient limitation of a change in the updated friction value.

Example 14 includes the method of any one or more of examples 1-13, further including selecting the overlay angle characteristic curve so that at least one of (i) the overlay angle characteristic curve causes only a negligible change in a steering rack force produced by the road wheel actuator, (ii) an amplitude of the overlay angle characteristic curve is smaller than an amplitude threshold value, or (iii) a frequency of the overlay angle characteristic curve is smaller than a frequency threshold value.

Example 15 includes the method of any one or more of examples 1-14, further including estimating a steering rack force produced by the road wheel actuator at least based on the steering command and the overlay angle characteristic curve.

Example 16 includes the method according to example 15, wherein the estimated steering rack force is based on filtering for a time period that corresponds to the actuating signal communicated to the road wheel actuator.

Example 17 includes the apparatus of any one or more of examples vehicle-16, the steer-by-wire steering system comprising at least one road wheel actuator operatively coupled to steerable wheels of the vehicle, a sensor, and a control device operatively coupled to the road wheel actuator and the sensor, wherein the control device is at least configured to identify a normal angle input for a road wheel angle of steerable wheels based on a steering command, identify an adapted angle input characteristic curve for the road wheel angle based on the normal angle input overlaid with an overlay angle characteristic curve, communicate an actuating signal to the at least one road wheel actuator based on the adapted angle input characteristic curve, the actuating signal to cause the road wheel actuator to track the road wheel angle of the steerable wheels based on the adapted angle input characteristic curve, detect at least one operating parameter influenced by the road wheel actuator during the tracking of the road wheel angle of the steerable wheels, determine an updated friction value of the road wheel actuator based on the detected at least one operating parameter, and adjust a current friction value of the road wheel actuator based on the updated friction value.

Example 18 includes the steer-by-wire steering system of example 17, wherein the control device adjusts the current friction value when a difference between the determined updated friction value and the current friction value is smaller than a difference threshold value.

Example 19 includes a vehicle comprising at least one road wheel actuator operatively coupled to steerable wheels of the vehicle, a sensor, and a control device operatively coupled to the road wheel actuator and the sensor, the control device to identify a normal angle input for a road wheel angle of steerable wheels based on a steering command, identify an adapted angle input characteristic curve for the road wheel angle based on the normal angle input overlaid with an overlay angle characteristic curve, communicate an actuating signal to the at least one road wheel actuator based on the adapted angle input characteristic curve, the actuating signal to cause the road wheel actuator to track the road wheel angle of the steerable wheels based on the adapted angle input characteristic curve, detect at least one operating parameter influenced by the road wheel actuator during the tracking of the road wheel angle of the steerable wheels, determine an updated friction value of the road wheel actuator based on the detected at least one operating parameter, and adjust a current friction value of the road wheel actuator based on the updated friction value.

Example 20 includes the vehicle of example 19, wherein the actuating signal is a first actuating signal, wherein the control device is to determine a second actuating signal to be communicated to the road wheel actuator based on the current friction value.

Although the disclosure has been illustrated and described with reference to one or more embodiments, a person skilled in the art is capable of making equivalent changes and modifications after having read and understood this description and the attached drawings.

1. A method for operating a steer-by-wire steering system for a vehicle, the method comprising:
receiving a steering command;
identifying a normal angle input for a road wheel angle of steerable wheels based on the steering command;
identifying an adapted angle input characteristic curve for the road wheel angle based on the normal angle input overlaid with an overlay angle characteristic curve;
communicating an actuating signal based on the adapted angle input characteristic curve to a road wheel actuator operatively coupled to the steerable wheels, wherein the actuating signal causes the road wheel actuator to track the road wheel angle of the steerable wheels based on the adapted angle input characteristic curve;
detecting at least one operating parameter influenced by the road wheel actuator during the tracking of the road wheel angle of the steerable wheels;
determining an updated friction value of the road wheel actuator based on the detected at least one operating parameter; and
adjusting a current friction value of the road wheel actuator based on the updated friction value.

2. The method according to claim 1, wherein the adapted angle input characteristic curve is identified in response to identification of at least one trigger condition being fulfilled.

3. The method according to claim 2, wherein the at least one trigger condition includes at least one of: (i) a predetermined time interval, (ii) a predetermined driving distance covered by the vehicle, (iii) at least one of a predetermined number of ignition procedures or charging procedures of the vehicle, (iv) a predetermined service interval, (v) at least one of an actuator temperature of the road wheel actuator or an ambient temperature that is at least one of below or above a respective temperature threshold value or within a predetermined respective temperature interval, (vi) a vehicle speed that is within a speed interval, (vii) a normal angle input that is at least one of within an angle interval or an angular speed interval, and (viii) a predetermined type of riding surface.

4. The method according to claim 1, wherein the overlay angle characteristic curve includes a characteristic curve of a varying overlay angle.

5. The method according to claim 4, wherein the characteristic curve of the varying overlay angle includes at least one of a sinusoidal characteristic curve, a square characteristic curve, a triangular characteristic curve, a sawtooth characteristic curve, or a random characteristic curve, and wherein a frequency of the characteristic curve of the varying overlay angle is constant.

6. The method according to claim 4, wherein the characteristic curve of the varying overlay angle includes at least one of a sinusoidal characteristic curve, a square characteristic curve, a triangular characteristic curve, a sawtooth characteristic curve, or a random characteristic curve, and wherein a frequency of the characteristic curve of the varying overlay angle varies.

7. The method according to claim 1, wherein the overlay angle characteristic curve has a duration that is shorter than a predetermined time threshold.

8. The method according to claim 1, wherein the actuating signal is a first actuating signal, further including determining a second actuating signal to be communicated to the road wheel actuator based on the current friction value.

9. The method according to claim 1, wherein the detected at least one operating parameter influenced by the road wheel actuator includes at least one of:
the overlay angle characteristic curve,
the normal angle input based on the steering command,
the road wheel angle,
a motor torque and/or a motor current of the road wheel actuator,
an electrical power consumed or mechanical power provided by the road wheel actuator,
a required amount of electrical energy of the road wheel actuator,
an expected value of the electrical power required by the road wheel actuator based on the adapted angle input characteristic curve, or
an expected value of the overlay angle characteristic curve detected with reference to the road wheel actuator based on the adapted angle input characteristic curve.

10. The method according to claim 1, wherein the updated friction value is determined based on at least one of:
a transfer function of a control path of at least one of the steer-by-wire steering system or the vehicle,
at least one of a Kalman filter or an estimating algorithm,
a change in at least one of an amplitude response or a frequency response of the adapted angle input characteristic curve identified based on the operating parameter,
a change in a cut-off frequency,
at least one of a time delay, an overshoot, or a static offset between a detected wheel angle of the steerable wheels and a nominal wheel angle of the steerable wheels, wherein the nominal wheel angle of the steerable wheels is based on an ideal transfer function of the actuating signal,
a change in an electrical power consumption of the road wheel actuator associated with at least one of successive overlay angle characteristic curves or a nominal characteristic curve, or
a change in a breakaway torque, wherein the breakaway torque is identified based on an electrical energy requirement consumed by the road wheel actuator.

11. The method according to claim 1, further including abandoning the determination of the updated friction value when an external disruption acting on the vehicle has a disruption amplitude that is greater than a predetermined amplitude threshold.

12. The method according to claim 1, wherein adjusting the current friction value occurs when a difference between the determined updated friction value and the current friction value is smaller than a difference threshold value.

13. The method according to claim 1, wherein the current friction value is adjusted based on at least one of: (i) filtering of the determined updated friction value, (ii) a sliding average value or a weighted average value associated with the updated friction value, or (iii) a gradient limitation of a change in the updated friction value.

14. The method according to claim 1, further including selecting the overlay angle characteristic curve so that at least one of: (i) the overlay angle characteristic curve causes only a negligible change in a steering rack force produced by the road wheel actuator, (ii) an amplitude of the overlay angle characteristic curve is smaller than an amplitude threshold value, or (iii) a frequency of the overlay angle characteristic curve is smaller than a frequency threshold value.

15. The method according to claim 1, further including estimating a steering rack force produced by the road wheel actuator at least based on the steering command and the overlay angle characteristic curve.

16. The method according to claim 15, wherein the estimated steering rack force is based on filtering for a time period that corresponds to the actuating signal communicated to the road wheel actuator.

17. A steer-by-wire steering system for a vehicle, the steer-by-wire steering system comprising:
at least one road wheel actuator operatively coupled to steerable wheels of the vehicle;
a sensor; and
a control device operatively coupled to the road wheel actuator and the sensor, wherein the control device is at least configured to:
identify a normal angle input for a road wheel angle of steerable wheels based on a steering command;
identify an adapted angle input characteristic curve for the road wheel angle based on the normal angle input overlaid with an overlay angle characteristic curve;
communicate an actuating signal to the at least one road wheel actuator based on the adapted angle input characteristic curve, the actuating signal to cause the road wheel actuator to track the road wheel angle of the steerable wheels based on the adapted angle input characteristic curve;
detect at least one operating parameter influenced by the road wheel actuator during the tracking of the road wheel angle of the steerable wheels;
determine an updated friction value of the road wheel actuator based on the detected at least one operating parameter; and
adjust a current friction value of the road wheel actuator based on the updated friction value.

18. The steer-by-wire steering system of claim 17, wherein the control device adjusts the current friction value when a difference between the determined updated friction value and the current friction value is smaller than a difference threshold value.

19. A vehicle comprising:
at least one road wheel actuator operatively coupled to steerable wheels of the vehicle;
a sensor; and
a control device operatively coupled to the road wheel actuator and the sensor, the control device to:
identify a normal angle input for a road wheel angle of steerable wheels based on a steering command;
identify an adapted angle input characteristic curve for the road wheel angle based on the normal angle input overlaid with an overlay angle characteristic curve;
communicate an actuating signal to the at least one road wheel actuator based on the adapted angle input characteristic curve, the actuating signal to cause the road wheel actuator to track the road wheel angle of the steerable wheels based on the adapted angle input characteristic curve;
detect at least one operating parameter influenced by the road wheel actuator during the tracking of the road wheel angle of the steerable wheels;
determine an updated friction value of the road wheel actuator based on the detected at least one operating parameter; and
adjust a current friction value of the road wheel actuator based on the updated friction value.

20. The vehicle of claim 19, wherein the actuating signal is a first actuating signal, wherein the control device is to determine a second actuating signal to be communicated to the road wheel actuator based on the current friction value.
